(19) United States
(12) Patent Application Publication
(10) Pub. No.: US 2012/0003048 A1
(43) Pub. Date: Jan. 5, 2012

(54) DEVICES AND METHOD FOR EQUIPMENT FOUNDATION IN THE SEA BED

(76) Inventors: Øyvind Hosøy, Soreidgrend (NO); Eldar Lien, Bergen (NO)

(21) Appl. No.: 13/139,667

(22) PCT Filed: Dec. 14, 2009
(86) PCT No.: PCT/NO2009/000433

§ 371 Date: Sep. 14, 2011

(30) Foreign Application Priority Data
Dec. 12, 2008 (NO) 20085187

(51) Int. Cl. F16L 1/12; E02D 11/00; E02D 27/52; E02D 27/50

(52) U.S. Cl. 405/172; 405/229; 405/184.4; 405/232; 405/224

(57) ABSTRACT

A device is described for a foundation to be placed in a sea bed, comprising a housing-formed, downwardly open, coat-forming construction set up for placing in the sea bed, said construction comprises a top part, and the top part comprises an extended hollow body (140) that stretches a distance into the inside of the construction. The invention is characterised in that the length of the inner pipe is shorter or longer than the length of the coat. When the inner pipe is shorter, its length is of the order of 10-90% of the length of the skirt 10, preferably 25 to 60%, and most preferred 50%. When the inner pipe is longer, its length is more than 100% and up to 300% of the length of the outer coat (10), preferably 150 to 200% and most preferred 300%. A method and different applications are also described.

The present invention relates to a new construction for making a foundation for equipment on the sea bed as it is defined in the introduction of the subsequent claim 1. The invention also relates to a method for the application of the construction mentioned above.

The invention relates in more detail to a device for a foundation to be fitted in sea bed, comprising a downwardly open, housing-formed construction forming a ring-formed outer skirt that is set up for being put down into the sea bed, said construction comprises a top part to which an inner pipe that runs a distance, or length, downwards inside the foundation, is fitted.

The invention relates to suction foundations in the sea bed which can be used for many purposes. Today, suction foundations are, in the main, used to anchor floating installations. The skirt is normally circular, and the inner pipe is fastened centrally to the top plate, but it can be made with other cross-section shapes than the circular shape. In the annular space which is defined between the outer coat or the skirt of the construction and pipe, an underpressure or suction can be set up, something which will lead to the whole of the construction sinking by its own weight down into the bed material of the sea bed.

Although one uses the expression suction foundation in the present application, this construction will also function as a conventional gravitation anchor with a weight which is so great that it sinks all the way down without one having to create any suction in the annular space. Thereby, the description suction anchor shall also cover the typical gravitation anchors.

In this connection, reference shall be made to the Japanese patent JP 61049029 where suction anchors to anchor floating installations to a sea bed are described. However, this solution is concentrated around a suction anchor that is to be placed in permeable soil (sand), and where the inner pipe functions essentially as a support frame for insertion of poles. The inner pipe is set up to create a closed suction space in the whole length of the anchor, i.e. as the inner pipe runs down to the point of the skirt. The pipe is primarily intended to lead a pole so that it stands upright and steady when it is driven into the sea bed. This is particularly necessary when the sea bed has a top layer which is hard or composed of sand. In such a case, the inner pipe can neither be shorter nor longer than the outer skirt of the anchor.

It is an aim according to a first aspect of the invention to provide a new anchoring construction where said internal pipe is shorter than the skirt length.

Furthermore, it is an aim according to a second aspect of the invention to provide a new anchoring construction where said internal pipe is longer than the skirt length.

The two versions, where the inner pipe is shorter or longer than the skirt, can be used in different application areas where suction anchoring can be used on the sea bed.

Thus it is an aim of the invention to provide new embodiments of the known anchoring units as given, for example, in the above mentioned JP patent.

Furthermore, it is an aim to provide new anchoring units that can be utilised actively under the different method steps for the installation of equipment that is necessary to start up a production from a hydrocarbon-carrying formation.

Consequently, with the present invention one aims, to a greater extent, to be able to develop this further so that suction foundations can now be better suited to be used to operate underwater wells for exploration of hydrocarbons, wells for a geotechnical purpose or a well for a seismic source.

It is an aim of the invention to provide a solution that can result in an improved sealing and stability of a suction foundation that is lowered down into a sea bed.

The device according to the first aspect of the invention is characterised by the features that appear in the claims 1-8, in which it is defined that the inner pipe is shorter than the outer coat or the skirt.

The device according to the second aspect of the invention is characterised by the features that appear in the claims 9-15, in which it is defined that the inner pipe is longer than the outer coat or the skirt.

The methods according to the invention are characterised by the features which are given in the claims 16-18.

A preferred embodiment of the invention is given in claim 19.

For the solution which is indicated above, for the first aspect, where a shorter pipe is applied, this is possible when the suction anchor functions as a gravitation anchor with a weight which is so great that it sinks all the way down without having to use suction. But it ought to be so far that it seals well enough when, for example, an overpressure must be used for the transfer of the load (see below). The advantage of a shorter pipe is great flexibility with the installation of the conductor in relation to the strict demands for verticality.

The advantages which are obtained with the present invention shall now be explained in more detail with reference to the enclosed figures.

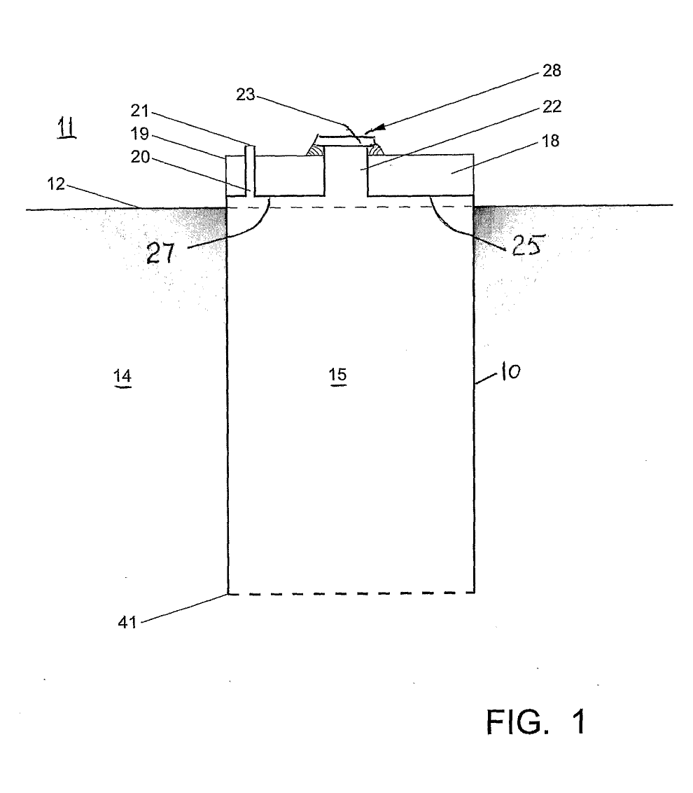

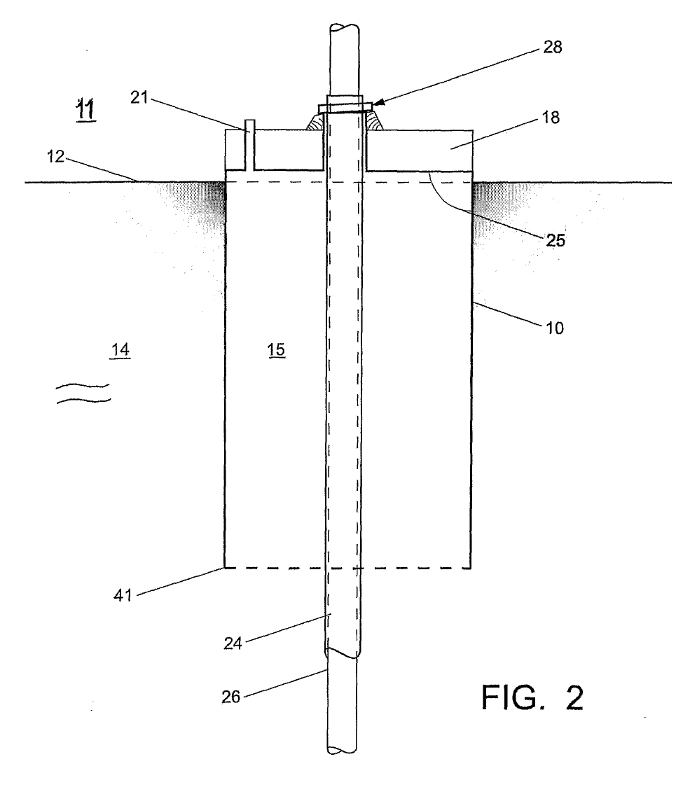

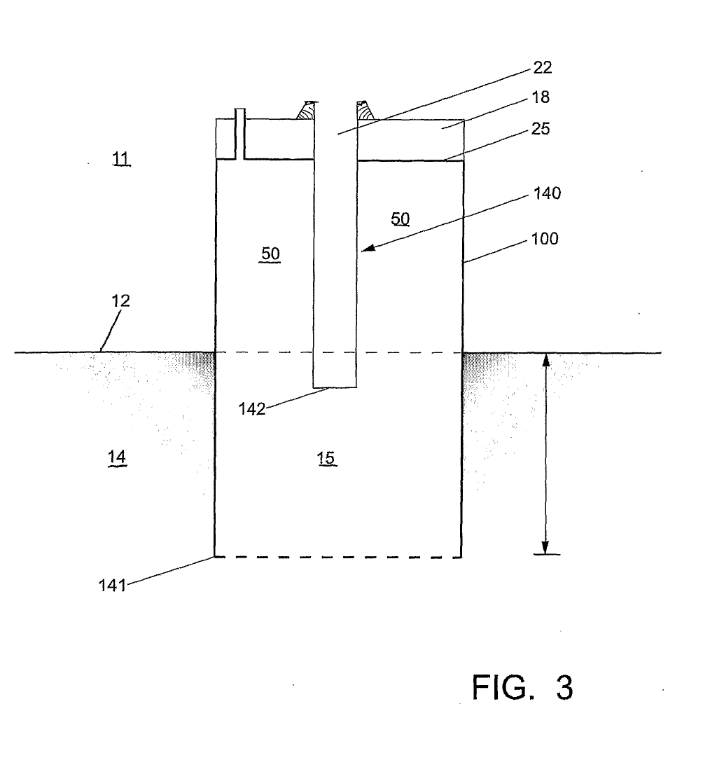

The FIGS. 1 and 2 show previously known solutions, while the FIGS. 3, 4, 5, 6 and 7 show different embodiments of the present invention.

Reference is initially made to the FIGS. 1 and 2 that show the construction of the known suction foundation 10 that is placed down into the sea bed shown by 12. The sea volume is shown by 11. The suction foundation, or the suction anchor 10 is, as a rule, a “box” with a circular (or other suitable cross-sections) or a square cross-section with a bottom 16 that opens downwards which is placed down into this soft bottom mass 14. Uppermost the foundation 10 comprises a top cover 18 with two openings 22 and 20. The opening 22 is a central opening which can be closed with a lid 23. A pipe 21 is inserted in the opening 20, which is used to suck out water that lies under the cover 18 inside the foundation.

Below the sea bed 12, there is normally a thick layer of soft mass 14 of a varying thickness, often more that tens of meters thick, which becomes more compact as the depth increases, and down into which the foundation shall be placed.

The inner volume of the box is filled with this soft mass given by 15. The box is lowered down so that its underside 25 nearly rests on the surface of the mass and is stabilised by this. The top cover 23 is put in place and water that lies on the surface of the mass 15 and under the roof cover 23 is pumped out through the pipe 21. This results in an underpressure inside the closed volume 27 which leads to the whole of the box sinking even lower down into the mass 15. The underside 25 (the roof) can thereby rest stably on the surface of the mass or the sea bed 12.

The principle is that during the installation, or when the above mentioned suction is created, the top cover 18 of the suction foundation in FIG. 1 must be completely leak proof. This means that the relatively large central hole 22 is closed with the lid 23 or another closing plug before the foundation is placed down into the sea bed.

Alternatively, this sealing can first be made when it is standing on the bottom and has penetrated so far into the mass as the weight of the device permits. The same sealing must, in any case, be removed after the foundation has sunk down to the predetermined depth of the foundation with the help of suction (evacuation of water), and before the well is established. All these operations which are associated with the installation and which normally take place from an offshore vessel are time consuming and thus very costly. The aim of the invention is to provide an improved construction that can eliminate these disadvantages.

The system looks as shown in FIG. 1 before the conductor, shown in FIG. 2, is installed by drilling, spraying and with the subsequent casting between pipe and soil, alternatively that the conductor is driven down by a pile driving rig.

The lid 23 is taken apart when the foundation is in place and in connection to the central opening 22 a conductor hanger for a conductor 24 which can now be led down through the opening 22 and down into the soft mass 15 is fitted, as shown in FIG. 2. The conductor functions as an inner pipe (guiding pipe) (typically a 30″ pipe) for an internally running casing, typically a 20″ pipe which can be led down into the mass and further down if and when required. The casing pipe can be cast or locked to the conductor.

The top lid 18 comprises means in the form of suspension equipment to fasten and hold the conductor 24 in position. The two pipes 24 and 26 lead further down inside the foundation 10 through the mass and down into the formation, and shall not be shown in more detail here.

When the inside of the foundation 10 is almost empty of water in the space 27, the conductor 24 and the casing 26 can, in turn, be lowered down through the opening and be fitted to the conductor hanger 28.

### THE PRESENT INVENTION

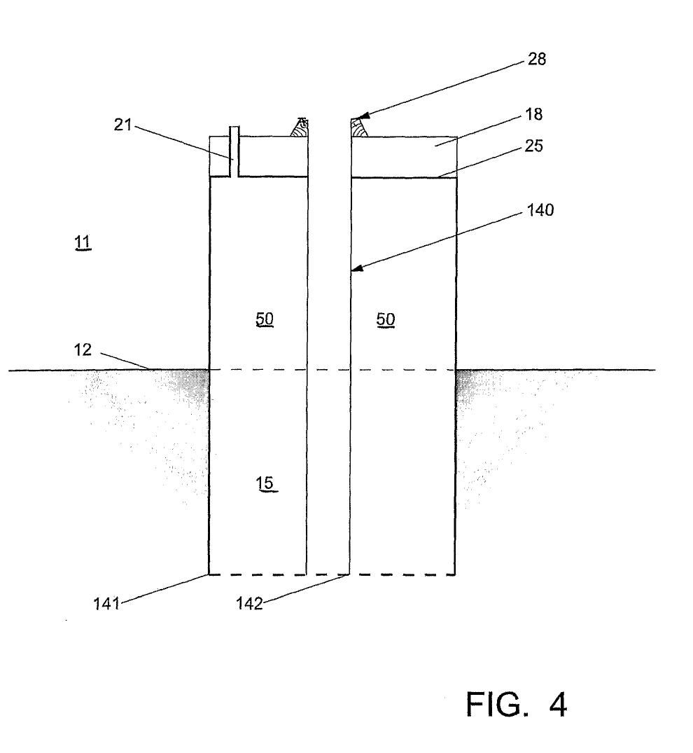

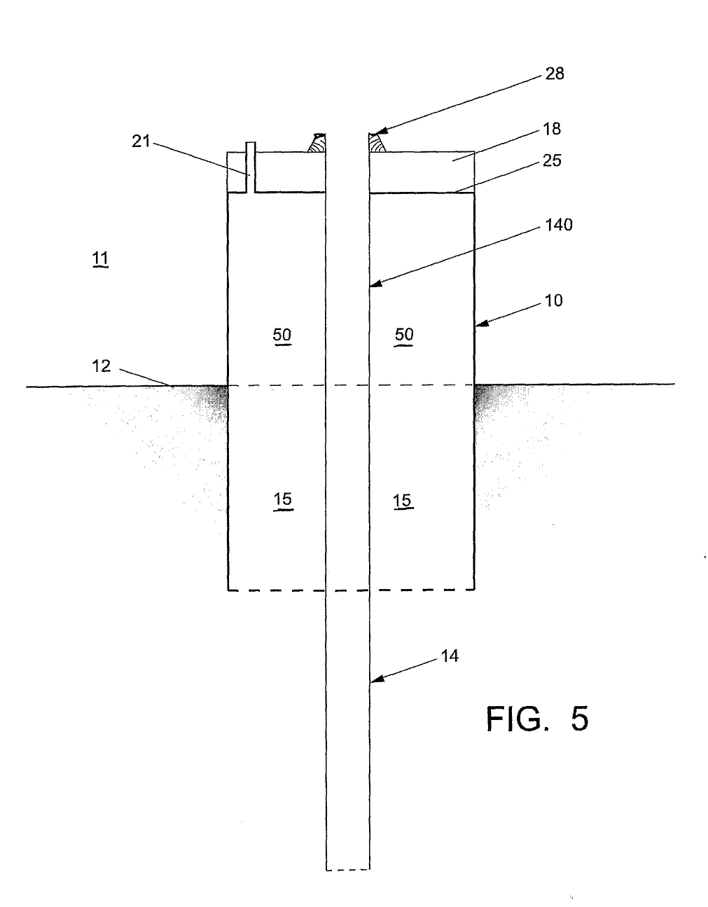

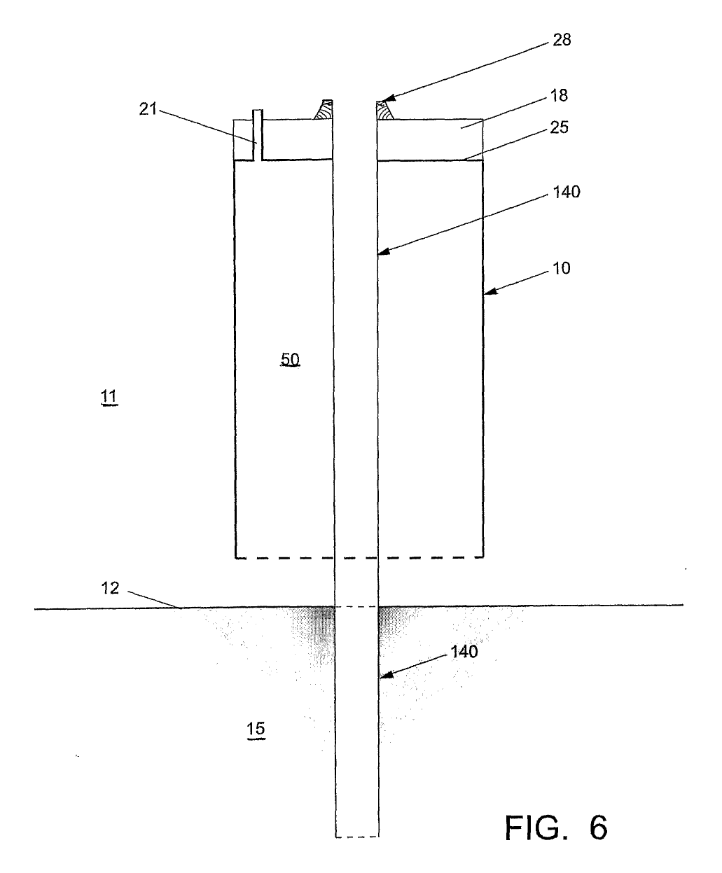

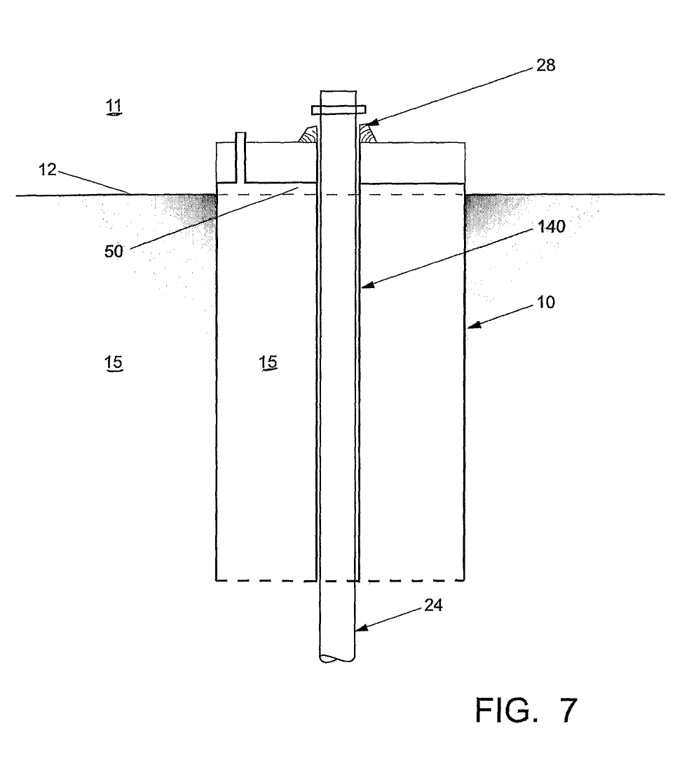

To describe the further development of the anchoring foundation, hereafter denoted the suction foundation, reference shall be made to the FIGS. 3, 4, 5 and 6 that show a foundation in the penetration phase in place down in the mass with an integrated inner pipe of different lengths. The inner pipe can be a guiding pipe. FIG. 7 shows the invention where a conductor is inserted and led down through the permanently fitted inner pipe 140. Of these figures, FIG. 3 shows an embodiment according to the first aspect of the invention, where the inner pipe 140 is shorter than the outer skirt 100, while the FIGS. 4 and 7 show embodiments where these are equally long, while FIGS. 5 and 6 show the second aspect of the invention where the inner pipe is longer than the outer coat 100, i.e. it extends out underneath and below the lower edge 141 of the foundation. In addition, the latter embodiment implies that it is the inner pipe 140 which first penetrates into the mass when the foundation is fitted in the sea bed.

It is the function and the aim of this pipe that the invention is related to.

According to the invention, the suction foundation comprises a permanently fitted inner pipe 140 which replaces the previously central opening 22 in the conductor hanger 28 in the top lid 18. The pipe extends down internally through the foundation 100. The inner pipe 140 can be open at the bottom so that the inner pipe also is filled with the material of the sea bottom.

These FIGS. 3-5 show the situation where the foundation construction 100 has been forced half way down through the mass 14 by its own weight. One can see that an annular space 50 is formed inside the foundation, which is defined by the top of the mass, the inner wall of the foundation, the outside of the inner pipe and the underside of the lid 18. This space is normally filled by seawater. When the underside 142 of the pipe 140 is forced down into the mass 15, this annular space 50 is completely isolated. And the water must be pumped out so that the foundation shall be able to be placed completely down on the mass surface. The pumping out is carried out in that the water is sucked out through the suction pipe 21 with the help of suitable pumping equipment coupled to the pipe. The foundation construction will then slowly sink down into the position which is shown in FIG. 7.

FIG. 7 shows a foundation which is fitted on the sea bed and with the inner pipe that extends down into the mass inside the foundation. A conductor is fitted through the inner pipe 140 as explained in the above.

The pipe length (and pipe diameter) of the elements are decided by the demand for verticality (angle with respect to the vertical) of the installed conductor, normally less than 1.5-2 degrees. And also the possibility to use the inner pipe itself as a conductor, dependent on the texture of the soil or how deep down the suction foundation is able to force the pipe into the sea bed.

Reference is in particular given to FIG. 6 where the inner pipe extends downwards beneath the lower edge of the suction foundation itself. When this suction foundation is put in place and equipment is lowered down through the inner pipe 140, this will come out into the sea bed mass as far down below the main construction of the suction foundation that the manipulation that thereby occurs in the sea bottom mass 15 does not affect the mass higher up towards the surface and does not influence the stability of the suction anchor in a negative way.

The suction foundation can have different appropriate cross sections, such as circular, square.

The inner pipe 140 can be led through the top plate 18 centrally as shown here and can also be placed through the plate 18 between the central area and the outer periphery of the foundation.

According to the first aspect where the inner pipe is shorter than the outer coat/skirt of the foundation, then the length of the inner pipe is of the order of 10-90% of the length of the skirt 10, preferably 25-60% and most preferred 50%. According to yet another preferred embodiment the inner pipe has a length of the order of 1 to 5 meters independent of the length of the outer coat/skirt.

According to the second aspect where the inner pipe is longer than the outer coat/skirt of the foundation the length of the inner pipe is of the order of above 100% and up to 300% of the length of the skirt 10, preferably 150 to 200%, and most preferred 300%.

Suction anchors or gravitation anchors of this type often have a diameter of 5-10 meters and a height (length) of 5-10 meters.

With the present invention the following advantages, savings and possibilities are obtained—both with the installation and the operation.

A suction foundation 100 with an integrated pipe 140 can be sucked down without a separate sealing of the pipe in the form of a central lid, plug or the like as the known solutions that are shown in FIG. 1 are encumbered with. The minimum length to achieve this is shown in principle in FIG. 3.

When the foundation has penetrated, with the help of its own weight, the lower opening of the pipe 140 must be in contact with soil or the mass 15 or that the end is surrounded by soil such that a suction can be applied through 20/21 to take out the water and sludge forms that may lie above the surface of the mass.

A suction foundation 100 with a pipe 140 that preferably extends down to the edge of the skirt 141 of the foundation, or deeper, has the same carrying ability and resistance to settlements as a foundation which is completely sealed at the top. This carrying ability/sealing is maintained all the time when the well is established and is operated.

The central hole 22 can be held open during all phases of the installation (putting out, lowering and penetration). Thereby, the hole 22 can be used for ventilation of internally displaced air and water without having to carry out underwater operations such as fitting and removal of lids and plugs.

The central ventilation through a “short” pipe, see FIG. 3, contributes to the verticality being maintained when the foundation penetrates with the help of its own weight.

A central ventilation through a pipe 140 which preferably is terminated at the edge of the skirt 141, contributes to that vertical movements during the lowering do not cause an overpressure or a water cushion under the foundation 100 just before it lands on the sea bed 12. Such a water cushion can result in a less precise positioning and tilting of the foundation.

An extended, integrated inner pipe with “surplus” length, see FIG. 5, will function as a guide for the foundation during the initial penetration when the verticality is consolidated, and before the suction starts. In this way the verticality will also be established and consolidated before the skirt of the foundation penetrates into the sea bed. Thereby, it will also be easier to reposition the foundation until the desired verticality has been obtained.

After installation of the conductor, the foundation can be subjected to an overpressure to force the top of the anchor out of the sea bed until a permanent contact in the suspension point of the conductor is ensured and verified. See FIG. 7. This is particularly important if it is not possible to drive the conductor towards full contact, or as an alternative to skim or put in wedges. The latter requires that the conductor is at first put under tension with, for example, wire pulls from the surface. Instead, the foundation can be forced upwards in a controlled movement with an overpressure. With a pipe that sticks out under the top of the foundation and down into the soil, this can be carried out without first having to seal the opening between the central hole and the conductor. (For this purpose the pipe may actually be shorter than the minimum length which is shown in principle in FIG. 3). Although this vertical adjustment of the foundation leads to more water under the top of the foundation, the sealing which the pipe maintains will ensure the carrying ability with relatively small adjustments.

By carrying out the same operation as described in the previous paragraph, the conductor can be put under tension if other conditions at the well demand this.

In situations where the sea bed, and thus the foundation, can sink over time because of tapping/draining of the underlying reservoir (hydrocarbon well), it will be possible for the foundation to maintain and restart its function by carrying out the same operation as the one described above.

For a well where the conductor is locked to the foundation and in a situation where a sinking sea bed causes the foundation to transfer its weight and resistance to the pulling out of the conductor, the increasing axial load on the conductor/casing system can be controlled/eliminated by carrying out the same operation as the one described above.

An inner pipe which preferentially extends down to the edge of the skirt of the foundation or beyond, will, during drilling or casting or setting of poles of the conductor hole, prevent the casting or setting of poles undermining the foundation or displacing internal soil.

An extended pipe, see FIG. 5, that penetrates sufficiently deeply or that gives a good contact with the soil, can replace a traditional/standard conductor. A 20″ casing (with BOP mm) can be hung directly onto the foundation or be cast to the permanent inner pipe.

Before installation, the inner pipe can be plugged tightly at the lower end so that, in this way if possible, it can compact the surrounding soil. A pipe which is closed in this way can be easier to drive down (suck down) than an open pipe where the internal friction contributes to the resistance to penetration.

Before installation, the inner pipe can be plugged tightly at its lower end so that is it possible to install an open well which is free from soil and in this way simplify the installation of the conductor or first casing.

For the establishment of a seismic well, the inner pipe can be plugged tightly at the lower end so that it will be possible to establish an open well where a seismic source can be placed at the bottom of the pipe. Such positioning will result in a deep and strong connection to the underground which is to be examined with the help of seismic imaging. At the same time the pipe will provide a very stable foundation for the source itself, which can thereby be installed without essential limitations on size/capacity.

The characteristics of the invention described in the last two paragraphs offer the possibility to establish a geotechnical well in an underground formation with hydrocarbons or with pockets of gas from a standard geotechnical drilling ship. For this purpose, the extent of sealing around the inner pipe can be combined with a relatively light BOP (Blow Out Preventer).

1. Device for a foundation for fitting in a sea bed, comprising a downwardly open, housing formed, coat-forming construction set up for being placed down in the sea bed, said construction comprises a top part, and the top part comprises an extended hollow body that protrudes some distance into the inside of the construction, characterised in that the length of the inner pipe is shorter than the length of the coat.

2. Device according to claim 1, characterised in that the length of the inner pipe is of the order of 10-90% of the length of the skirt 10, preferably 25% to 60%, or most preferred 50% of the length of the skirt 10.

3. Device according to claims 1-2, characterised in that the inner pipe has a length of the order of 1 to 5 meters, independent of the length of the outer coat/skirt.

4. Device according to claims 1-3, characterised in that the hollow body is a pipe.

5. Device according to claims 1-2, characterised in that it is set up to stabilise the position of the foundation in the mass on the sea bed.

6. Device according to one of the preceding claims, characterised in that the hollow body is set up as an inner guiding pipe to take up and lead the equipment that shall be led further into the formation, said equipment can comprise casing pipes that run through a conductor set up through the inner guiding pipe.

7. Device according to one of the preceding claims, characterised in that the foundation construction has different cross sections, such as circular or square.

8. Device according to one of the preceding claims, characterised in that the inner pipe 140 is led centrally through the top plate 18, or is set up to run through the plate 18 between the central area and the outer periphery of the foundation.

9. Device for a foundation to be placed in a sea bed, comprising a housing-formed, downwardly open, coat-forming construction set up to be lowered into the sea bed, said construction comprises a top part and the top part comprises an extended hollow body that stretches a distance internally into the construction, characterised in that the inner pipe is longer than the outer coat (10).

10. Device according to claim 9, characterised in that the length of the inner pipe (140) is of the order of 100% and up to 300% of the length of the outer coat (10), preferably 150 to 200%, and most preferred 300% (three times the length) of the length of the outer coat (10).

11. Device according to claims 9-10, characterised in that the hollow body is a pipe.

12. Device according to claims 9-11, characterised in that it is set up to stabilise the position of the foundation in the mass on the sea bed.

13. Device according to one of the preceding claims 9-12, characterised in that the hollow body is set up as an inner guiding pipe to take up and lead equipment that is to be led further into the formation, said equipment can comprise casing pipes that run through a conductor set up through the inner guiding pipe.

14. Device according to one of the preceding claims 9-13, characterised in that the foundation construction has different suitable cross sections, such as a circular shape or a square shape.

15. Device according to one of the preceding claims 9-14, characterised in that the inner pipe 140 is lead through the centre of the top plate 18, or is arranged through the plate 18 between the central area and the outer periphery of the foundation.

16. Method for the application of the foundation anchor, for connecting of equipment in connection with an installation, characterised in that the upper annular space between the inner pipe (140) and the coat (10) is subjected to an overpressure by the pumping in of water such that the anchor moves upwards to force the top of the foundation up from the sea bed (12) to maintain coupling contact between the inner pipe and a suspension point for a conductor.

17. Method according to claim 16, characterised in that a plugged inner pipe is used to contribute to compact the surrounding mass in the sea bed, and also to eliminate resistance to penetration from the inside of the inner pipe.

18. Method according to claims 16-17, characterised in that the equipment in the well and which is connected to the anchor, is under tension by supplying more overpressure in the annular space.

19. Application of the device according to the preceding claims for anchorage of floating installations and/or to operate underwater wells for the exploration of hydrocarbons, wells for a geotechnical purpose or a well for a seismic source.
